(19) United States
(12) Patent Application Publication
(10) Pub. No.: US 2015/0136498 A1
(43) Pub. Date: May 21, 2015

(54) TRANSPORT CART CONFIGURED TO TRANSPORT BEDS WITH WHEELS

(71) Applicant: MIM HOLDING A/S, Ikast (DK)

(72) Inventors: Hans Wichmann Madsen, Vejle (DK); Arne Just Bech, Ikast (DK)

(21) Appl. No.: 14/395,623

(22) PCT Filed: Apr. 17, 2013
(86) PCT No.: PCT/DK2013/050106

§ 371 Date: Oct. 20, 2014

(30) Foreign Application Priority Data
Apr. 18, 2012 (DK) PA 2012 70193

(51) Int. Cl. A61G 7/08

(52) U.S. Cl. CPC A61G 7/08
USPC 180/11

(57) ABSTRACT

This invention relates to a transport cart having an X-Y orientation with an X-direction essentially being the driving direction and a Y-direction essentially being perpendicular to the X-direction, both relative to a fixed A-Point, which transport cart is for working on a surface and thereon moving a bed with a bed end and a duct raised from the surface to a height and entering underneath a bed in depth and which bed is supported by bed wheels, which bed preferably is a hospital bed, which transport cart comprises:
a chassis supported by at least a first wheel arrangement and a second wheel arrangement, which wheel arrangements are configured to support the chassis and to drive the chassis in the X-direction, which first wheel arrangement interacts with steering means and which second wheel arrangement is spaced from the first wheel arrangement in the X-direction and is arranged to face and enter a duct of a bed end, and which chassis further supports
at least one grip configured to grip a bed wheel of a bed and for moving a bed.

### BACKGROUND OF THE INVENTION

1. Field of the Invention

The present invention relates to transport systems for wheeled units and in particular beds such as those used in hospitals. Such transport cart or transport system is known from the back-ground art or the abstract of this application.

2. Description of Related Art

A starting point for a transport system or transport cart is a cart disclosed U.S. Patent Application Publication 2008/0101903 A1.

Such transport cart is suitable for separating bed wheels from the ground by so-called blade members of a certain width to allow for some flexibility when placing the blade members to engage with wheels on a bed. The blade members are concave and can tilt to secure the bed wheels during transport.

The transport cart however has some deficiencies as inferred by the objects of the invention.

NL 1016924C describes a transport cart but this transport cart is not very flexible in the sense that only beds with wheels at specific positions can be moved by the cart.

### SUMMARY OF THE INVENTION

An object of this invention is to provide a transport cart that can be used to transport wheeled units and in particular hospital beds of different sizes and configurations and hence with different location/dimensions (width between a pair of wheels, spacing from the (foot or head) end of a bed to the wheels, and the height from the floor to the bottom of the bed) of a wheel, a pair of wheels or generally an arrangement of wheels.

An object of the invention is to provide a transport cart that easily can be adapted to different configured hospital beds with different types or sizes of wheels.

An object of the invention is to provide a simple solution that easily engages the wheels of a bed.

An object of the invention is to provide a simple solution that easily secures or locks the wheels of a bed for a safe transport of the bed.

An object of the invention is to provide a transport cart that minimises the space required around a hospital bed.

An object of the invention is to provide a transport cart that easily can engage, lock and transport a bed whilst overall minimising the required pull (push) of the bed by an operator, thereby minimising forces on particular the torso, shoulders, and arms of the operator.

Accordingly, this is achieved by a transport cart having an X-Y orientation with an X-direction essentially being the driving direction and a Y-direction essentially being perpendicular to the X-direction, both relative to a fixed A-Point, which transport cart is for working on a surface and thereon moving a bed with a bed end and a duct raised from the surface to a height and entering underneath a bed in depth and which bed is supported by bed wheels, which bed preferably is a hospital bed, which transport cart comprises:
a chassis supported by at least a first wheel arrangement and a second wheel arrangement, which wheel arrangements are configured to support the chassis and to drive the chassis in the X-direction, which first wheel arrangement interacts with steering means and which second wheel arrangement is spaced from the first wheel arrangement in the X-direction and is arranged to face and enter a duct of a bed end, and which chassis further supports
at least one grip configured to grip a bed wheel of a bed and for moving a bed.

As such the shape of the chassis and the second wheel arrangement is so that it can enter underneath a bed with wheels. That is to say that the shape of the chassis is complementary in shape to the shape of the space underneath a bed end. Typically a bed end is raised some 400-500 mm, and in particular 330 mm at the very end of the bed. This extends under the bed for a certain, but variable length, typically some 200-900 mm where the wheels of the bed is supported and accessible from the end of the bed at a height of some 100-400 mm. These dimensions are only examples, and a person skilled in the art will easily be able to shape the chassis and the second wheel arrangement to allow it to enter underneath a particular end of a bed.

The grip is configured to catch and hold a wheel of a bed, typically a wheel of a hospital bed having a diameter of some 150-225 mm and a width of some 20-50 mm.

The grip can have a certain width (in the Y-direction) so that it can accommodate bed wheels with a width of a certain variation. Also having two grips each with a certain width and spaced in the Y-direction will allow for the transport cart to engage with beds having wheels spaced within a certain fixed span.

According to an embodiment of the invention, the invention is further special in that the chassis comprises an X-positioning means for moving said at least one grip relative to the position A in the X-direction for positioning the grip to engage with at least one wheel of a bed.

Thereby a grip of the transport cart can be positioned to engage with a wheel on a bed whilst the main body of the chassis is predominantly at the edge of the end of a bed, but preferably with some part underneath a bed. Thereby, the transport cart gets as close to the bed as necessary for operation, i.e. moving a bed, and preferably a hospital bed in a hospital environment with corridors, elevators etc. So that the transport cart gets its centre of gravity as close to the bed as possible so that the transport cart and bed when engaged essentially act as one unit.

A particular advantage is that the same transport cart can be used at a hospital with multiple bed types and in particular beds with same frame sizes, but with different wheel arrangements or equipment placed underneath. Hence, the transport unit engaged to a any bed, within certain limits, will take up more or less the same combined space (length in the X-direction) and hence be able to function in an environment with sparse space, such as elevators, theatres, and when parked in corridors.

A further advantage is that the combined unit for multiple beds will have more identical driving characteristics, which will lessen the distress of the operator, lessen damages such as accidents ranging from dents in walls, doors and more serious impacts with valuable hospital equipment in theatres.

A further advantage is that a transport cart with properly positioned grips (in the X-direction) will reduce the forces and strain on the operator whilst engaging the grip of the transport unit with a hospital bed

Thereby the transport cart becomes more easily operational, and the operator will experience reduced strain whilst positioning the cart as the relative position of the main body and steering of the transport cart will be in a more similar position relative to a bed and hence make the engaging procedure more standardised.

The X-positioning means can be configured to be adjustable so that a grip position in the X-direction can be changed according to a particular bed; and then used on the particular bed fixed on the chassis by means of tension.

The X-positioning means can be configured to be adjustable so that a grip position in the X-direction can be changed automatically and flexibly before engagement to a particular bed.

This will further allow for adjusting the transport cart to the bed thereby further fine adjusting the combined bed-transport cart unit and the advantages outlined.

Preferably the X-positioning means are configured so that the grip is between the first wheel arrangement and the second wheel arrangement. Most preferably configuration of the second wheel arrangement and the configuration of the chassis is made so that the second wheel arrangement extends underneath a bed past the wheels of the bed so that the forces acting between the transport cart and a bed are transferred to the transport cart between the first and second wheel arrangement.

According to an embodiment of the invention, the invention is further special in that said chassis further supports a Y-positioning means for moving said least one grip relative to the position A in the Y-direction in the X-Y-plane for positioning the grip to engage with at least one wheel of a bed.

Thereby a grip of the transport cart can be positioned to engage with beds with different spacing between wheel-pairs (in the Y-direction).

Similar to the X-positioning means the Y-positioning means can be manually adjustable or automated/flexible before engagement.

In particular a combination of X-positioning means and Y-positioning means can be further advantageous as it will allow a grip to be positioned in the X-Y-plane.

The most flexible embodiment is when each grip can be positioned individually and independent of another grip in the X-Y-directions.

However, the person skilled in the art will recognise that it will be less complex to make a pair of grips that can be positioned either in the X-direction, in the Y-direction or in the X-Y-direction as a pair.

According to an embodiment of the invention, the invention is further special in that said X-positioning means comprises a linear X-bar extending in the X-direction and the grip attached to an X-glider configured to glide on the linear X-bar for positioning the grip in the X-direction.

Thereby a constructionally simple, strong and effective X-positioning configuration is provided.

The X-bar can advantageously be part of the chassis that supports a wheel of the second wheel arrangement.

The X-bar can have a cross section profile that is complementary to that of the X-glider.

In a motorised version the X-glider is moved by a motor or an actuator fixed on the chassis via a belt connection.

According to an embodiment of the invention, the invention is further special in that said Y-positioning means comprises a linear Y-bar extending in the Y-direction and the grip attached to a Y-glider configured to glide on the linear Y-bar for positioning the grip in the Y-direction.

Thereby a constructionally simple, strong, and effective Y-positioning configuration is provided.

The Y-bar can have a cross section profile that is complementary to that of the Y-bar.

The Y-bar can advantageously be part of the chassis and extend between two X-bars. In a particular embodiment, the Y-bar can be connected to a pair of X-gliders thereby forming a simple X-Y-positioning construction that is strong.

In a particular embodiment, a grip is connected to a Y-glider, gliding on a Y-bar that is connected to an X-glider at each end, which X-glider glides on two X-bars supporting the second wheel arrangement. This construction is particularly simple and strong and suitable for allowing the grip to engage with wheels on a bed. It furthermore allows for the transport cart to be positioned as close as operationally possible to the bed.

In a motorised version the Y-bar is moved in the X-direction by a motor or an actuator fixed on the chassis via a belt connection.

According to a particular and safer embodiment of the transport cart, it is configured so that the X-positioning and the Y-positioning means can only be adjusted or used when the grip is in touch with the ground. Thereby loads on the actuators etc are reduced since they can only be operated without the loads from a bed.

According to an embodiment of the invention, the invention is further special in that said grip comprises a wheel support plate configured to receive and support a wheel and sided by two wheel fences forming an wheel enclosure closable by a wheel gate facing the wheel support place, which wheel enclosure preferably has a an wheel opening downwards or U-shape for holding a wheel in position by its geometric shape and the gravitational force.

Thereby a bed wheel on a surface can be partially surrounded as the wheel fences enclose a bed wheel in the Y-direction until the wheel support plate is in contact or in the vicinity of the wheel (in the X-direction). Thus, a bed wheel can be approached whilst standing on a floor and with a minimum of efforts and energy. Thereafter, the wheel gate can be closed thereby fully enclosing or surrounding the bed wheel as it stands on the floor at a contact area in the wheel opening.

This wheel enclosure is particularly advantageous as it allows the operator to position the grip and engage the grip around a bed wheel with very small forces. This greatly reduces the need for movements of the transport cart and forces needed to engage the transport cart with a bed.

In particular, it reduces or even eliminates larger forces on the torso of the operator in movements otherwise needed to push and pull (in the X-direction) the transport cart to “get under” the bed wheels or otherwise engage with the bed wheels.

In an embodiment, the wheel gate is at one end fixed on one wheel fence and with means for locking to the other wheel fence at its other end.

The wheel fences are further advantageous in that they provide directional support or guidance for a wheel to be enclosed in the wheel enclosure. The wheel fences are aligned in the X-direction and will ensure that a bed wheel received in the wheel enclosure will align predominantly in the X-direction. This will reduce negative impacts on the bed wheel during operation i.e. engagement, transport, stand-still etc since most bed wheels are designed with a preferred operational direction, which will be aligned with the X-direction when the transport cart is engaged. Hence forces resulting from bumps, turns, etc will be transferred to a bed wheel when it is in a position in which it is designed to be most robust.

According to an embodiment of the invention, the invention is further special in that said wheel gate is a bar with threads interacting a gate motor thereby forming an actuator for linearly moving said bar.

Thereby a simple construction of the wheel gate in the wheel enclosure is provided.

According to an embodiment of the invention, the invention is further special in that said chassis further supports grip-raising means connected to said grip and configured to raise said grip from above the surface.

Thereby, the grip engaged with a wheel of a bed can raise the wheel of the bed and hence lift one end of a bed from the ground, making it easy for transport by the transport cart.

Typically, the transport cart with the wheel arrangements will form one end of a combined vehicle, and the other end than that of the raised end of a bed will form another end of the combined vehicle.

The grip-raising means can be manual or motorised. In one embodiment the grip raising means is a linear actuator, say with a spindle-arrangement, configured to lift the grip off the ground. The construction is typically built for between 100 kg to 450 kg, but the numbers are only indicative and a person skilled in the art will easily find raising means that can lift beyond that range.

According to an embodiment of the invention, the invention is further special in that said chassis further supports wheel-locking means configured to lock a bed's wheels to the grip.

Thereby, the bed can securely be combined with the transport cart so that the bed can be moved.

In an embodiment, the wheel-locking means are tightening means tightening the grip to a bed wheel. This can be simple plates or brakes configured to press against the tyre of the bed wheel.

In a particular embodiment the wheel-locking means have a key-lock, so that the combined transport cart and bed can be parked and not disengaged without a key.

According to an embodiment of the invention, the invention is further special in that said wheel-locking means comprise tilting-means for tilting said grip so that the bottom point of the U-shaped valley is shifted in relation to a wheel's axis and thereby by gravitational forces due to the weight of a bed constitutes a locking force, preferably the tilting is so that the U-shaped valley is shifted away from the grip support plate, and most preferably so that the U-shaped valley is shifted away from the point A of the chassis.

According to an embodiment of the invention, the invention is further special in that said wheel-locking means comprise tilting-means for tilting said grip and is arranged so that when tilted, the gravitational forces due to the weight of a bed constitute a locking force, preferably the tilting is towards the grip support plate.

Thereby the components of the gravitational forces from the end of the bed when raised by the grip when it is tilted will be directed towards the first wheel arrangement i.e. main body of the transport cart and thereby constitute an effective wheel-lock where the locking forces are the forces from the bed to the wheel support plate.

It is understood that the wheel enclosure with the wheel opening will have two contact areas in the X-direction with a bed wheel. Tilting of these contact areas towards the main body of the transport cart will make the wheel “run” towards the main body of the transport cart and thereby make a bed “run” in the towards the transport cart, making the two units by gravitational forces stay together when lifted and tilted.

According to an embodiment of the invention, the invention is further special in that chassis further supports a stand that is essentially flat and configured to flip to a horizontal position.

Thereby, an operator can stand on the transport cart when it is moving. When flipped to a horizontal position, preferably towards the main body of the transport cart, it will take up less space.

According to an embodiment of the invention, the invention is further special in that said chassis further comprises a drive train, preferably comprising batteries, an electric engine coupled to the first wheel arrangement for driving said wheels and further configured to be controlled by a steering wheel.

Thereby, the transport cart is motorised. In an embodiment, the power system of the drive train will be integrated with motors and actuators for thereby effectively utilising the power system on the transport cart.

According to an embodiment of the invention, the invention is further special in that said part of the chassis between the first wheel arrangement and the second wheel arrangement and for entering underneath a bed end has a height of less than 50 cm, preferably less than 33 cm, and said drive train's heavier components are fitted to below said height. Thereby, it is ensured that the centre of gravity of the transport cart is as low as possible and can be placed underneath the bed end.

In a an embodiment, the second wheel arrangement and the grip extends from the main body of the transport unit in the X-direction at a height of less than 40 cm, preferably less than 23 cm. Thereby, it is ensured that the secondary wheel arrangement can extend past the bed wheel arrangement.

An objective of the invention and/or a further embodiment of the invention is a transport cart with a chassis that further supports a combined grip raising and tilting means implemented as an arm arrangement comprising:
a lower arm with a lower arm joint engaging in a lower arm attachment fixed on the chassis;
an upper arm with an upper arm joint engaging in an upper arm attachment fixed to the grip or to a grip connector pivotably connected to the chassis at a grip pivot joint; which lower arm and upper arm pivotably connects at
an elbow in an elbow joint so the lower arm and the upper arm can bend about the elbow joint, which elbow further has an arm actuator bar joint connecting an arm actuator bar to
an arm actuator connected, preferably pivotably, to the chassis at an arm actuator joint and configured for pulling and pushing the elbow to bend and stretch the lower arm and upper arm relatively to each other.

Thereby, a single arrangement that can raise and tilt the gripping means is provided. As forces from the actuator, via the arm actuator bar, press the elbow towards a line between the two upper and lower arm joints, the lower arm and the upper arm will stretch and increase the distance between the two upper and lower arm joints in the chassis and the grip or grip connector, thereby tilting the grip around the grip pivot point and at the same time raising the grip from the surface.

In an embodiment, the actuator is a linear actuator arrangement with a spindle as the actuator bar.

In an embodiment the lower arm joint and upper arm attachment as well as the lower arm joint and the lower arm attachment are ball-and-socket joints arrangements.

According to an embodiment of the invention, the invention is further special in that the arm arrangement is configured so that the lower arm and upper arm can over-stretch and with the arm arrangement having an arm lock support point that defines a maximum over-stretch and supports at least part of the load-forces from each said upper arm and lower arm.

Hence, when the arm is overstretched, the forces from the load on the grip are diverged from the direction of the actuator. In particular, the arm lock support point ensures that the arm will only overstretch to a certain point where the position is held. This means that the arm arrangement can be used to lift and tilt and thereby locking the bed wheels to the grip to beyond the maximum stretch where the forces will be diverged from the actuator and taken in the arm lock support point. This is particularly advantageous as for transport, since the bed in this position is statically engaged to the transport cart and the forces, and spikes in forces due to impacts of the bed, will be diverged to the arm lock support point rather than to the actuator. It furthermore enhances the lifespan of the actuator and hence the transport cart. Another advantage is that a transport cart with a raised bed can be parked, and switched off, and left and remain statically locked together rather than having forces working on an actuator, pneumatics or alike.

According to an embodiment of the invention, the invention is further special in that the said arm lock support is a bolt inserted in the elbow in a position between the elbow joint and the arm actuator joint or the said arm lock support is a contact point between the lower arm, the upper arm or the elbow with the chassis. Thereby providing alternative embodiments of the arm overstretch lock, which embodiments are simple and strong enough to take the forces from a raised bed.

According to an embodiment of the invention, the invention is further special in that said chassis further comprises a drive train, preferably comprising batteries, an electric motor coupled to the first wheel arrangement for driving said wheels and further configured to be controlled by a steering board.

An objective of the invention is achieved by a raising and tilting arrangement according to FIG. 8, as disclosed, and configured to lift and tilt a grip on a transport cart for moving a hospital bed.

In a particular embodiment, a transport cart with a first and a second wheel arrangement is retrofitted with a raising and tilting arrangement as disclosed and in particular the arm arrangement disclosed.

The scope of this invention is by no means limited to transporting beds. In fact the transport cart can be used to a vehicle with wheels chosen from a plurality of types including, but not excluding, wheel chairs, tables with wheels, boxes or carts with wheels etc.

The invention is described by example only and with reference to the drawings, wherein:

### BRIEF DESCRIPTION OF THE DRAWINGS

FIG. 1 shows a transport cart seen from above and with grips placed in a position and locked;

FIG. 2 shows a transport cart seen from above and with grips placed in a position and un-locked ready to engage in wheels of a bed;

FIGS. 3A and 3B shows a transport cart seen from the side in two situations: A, where the grip is closed around a wheel of a bed and B, where the grip is raised above a surface;

FIGS. 4A and 4B shows a transport cart in similar situations as in FIG. 3, but with a ghost view showing an embodiment of a grip-raising means shown in two positions: A, where the grip is placed so that a wheel enclosed by a grip has contact to a surface and B, where the grip is raised and a bed end is raised from the surface;

FIG. 5 shows an embodiment of a grip raising means shown in tow positions: A and B.

FIG. 6 shows an isometric view of a transport cart from above;

FIG. 7 shows an isometric view of a transport cart from below; and

FIG. 8 shows a detailed view of an arm arrangement.

### DETAILED DESCRIPTION OF THE INVENTION

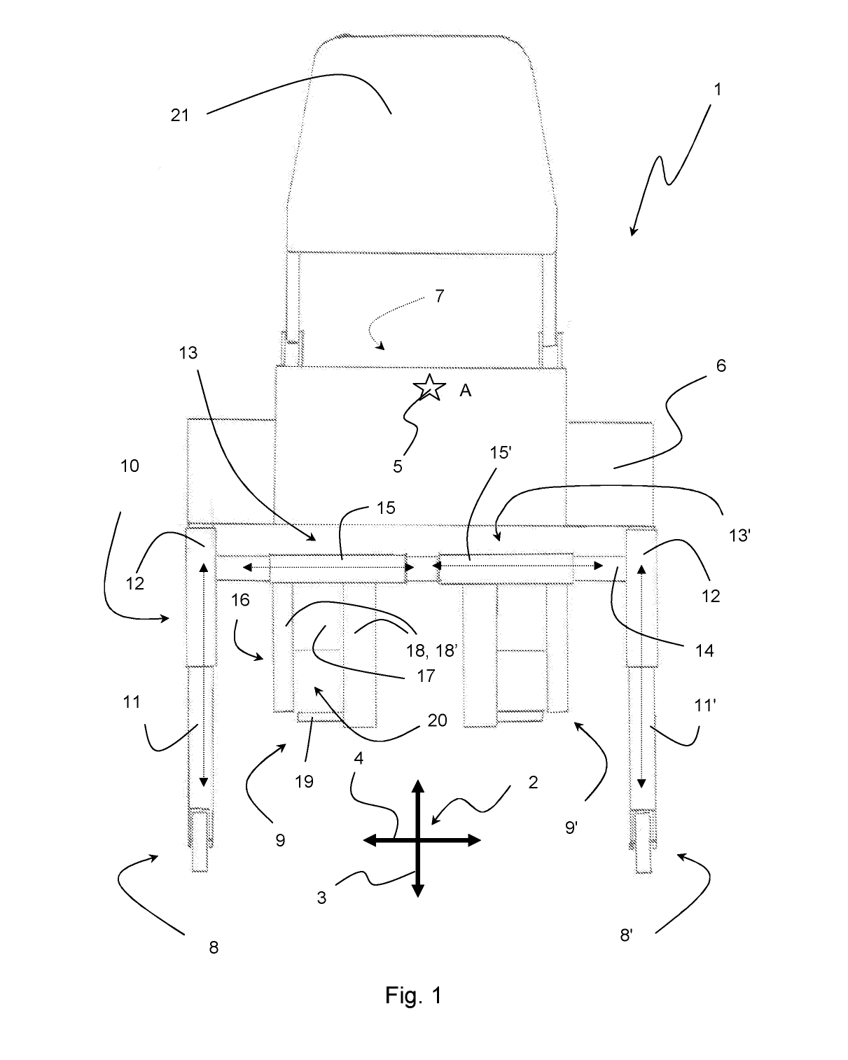

FIG. 1 shows an embodiment of a transport cart 1 for working in an X-Y-plane 2 according to an X-direction 3 and a Y-direction 4. The X-Y-plane 2 and X-direction 3 and Y-direction 4 are implied and movements and positions are defined relatively to an A-point 5, as a fix-point, of the transport cart 1.

The figure shows the transport cart 1 as seen from above.

The transport cart 1 has a chassis 6 with a first wheel arrangement 7 (not from this view) and a second wheel arrangement 8. The chassis 6 supports grips 9, 9′ that are movable in the X-direction 4 by X-positioning means 10, which in this embodiment comprises two X-bars 11, 11′ extending out from the body of the chassis 6 and is terminated by wheels. There is an X-glider 12, 12′ that can glide on each X-bar 11,11′ and which in this embodiment supports Y-positioning means 13 by having a Y-bar 14 going between the X-bars 11,11′ and having Y-gliders 15, 15′ each supporting the grip 9,9′ that in this embodiment is formed as a wheel enclosure 16.

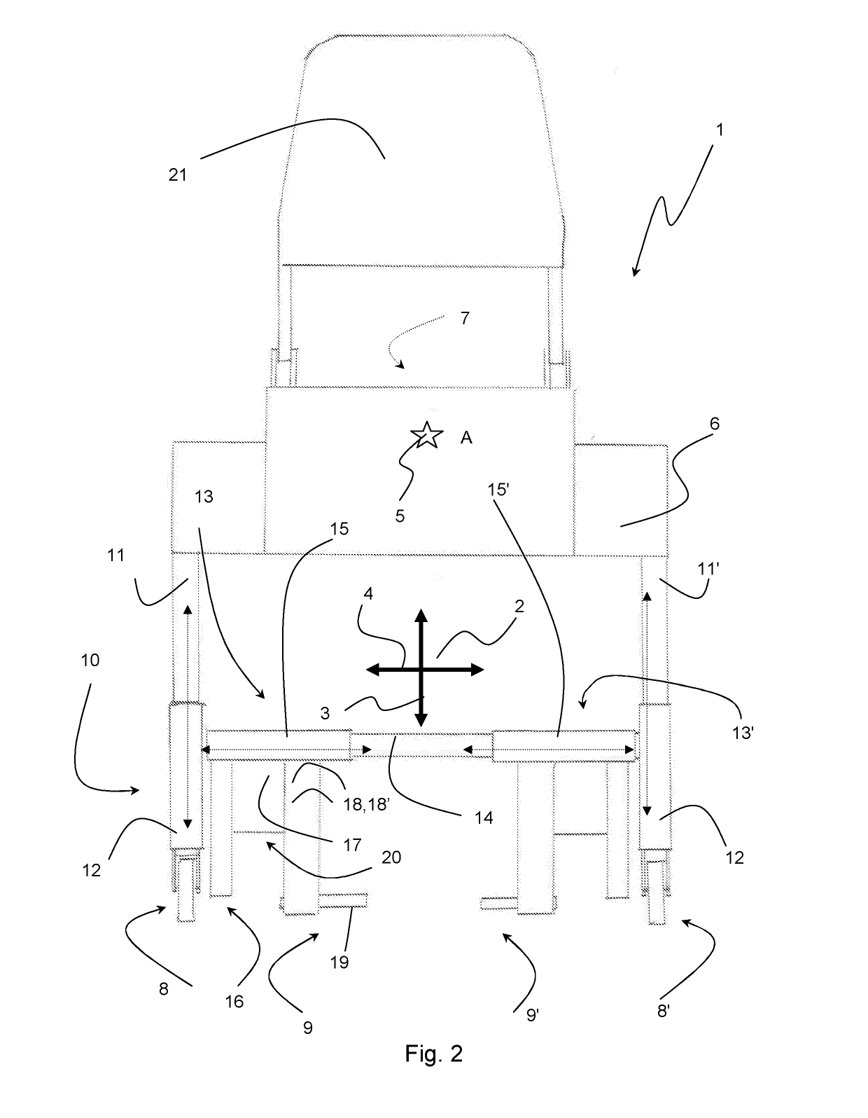

FIG. 2 shows a transport cart seen from above and with grips placed in a position and un-locked ready to engage in wheels of a bed.

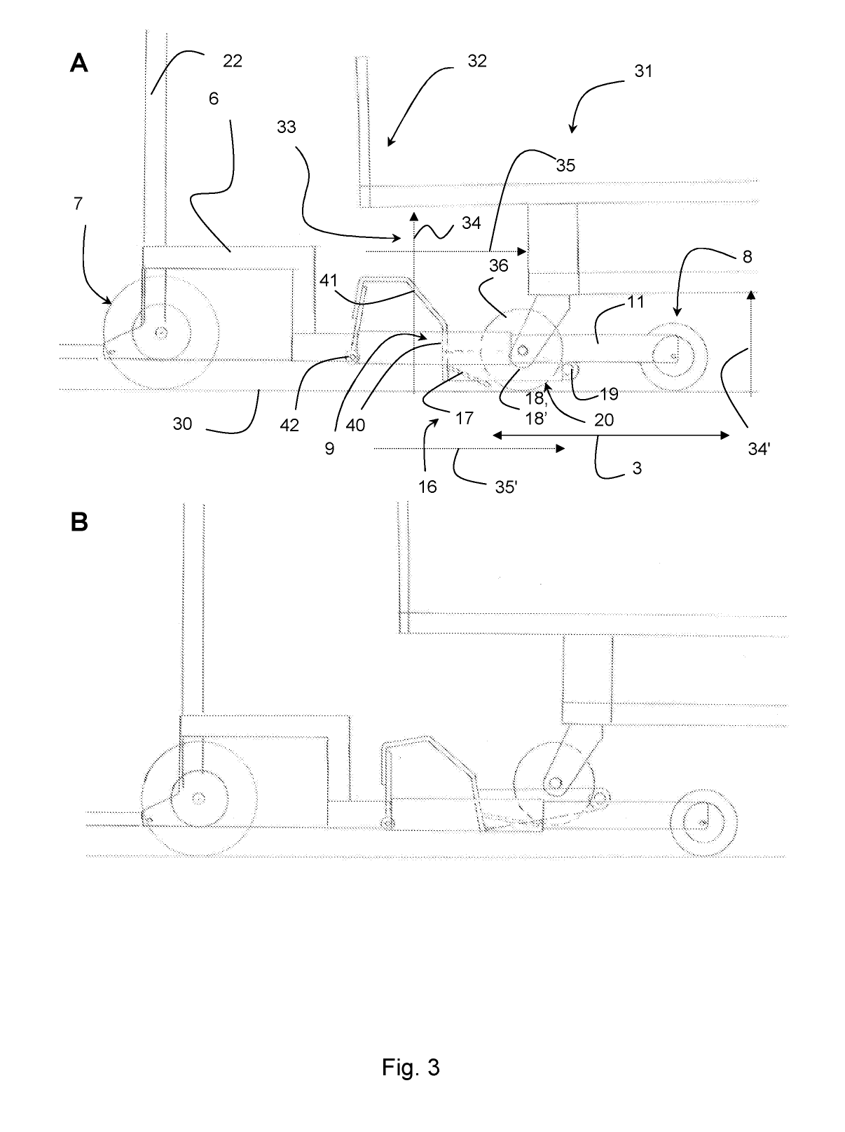

FIGS. 3A and 3B shows an embodiment of transport cart 1 seen from the side in two situations: A and B in relation to a surface 30.

Although a bed 31 is not part of the invention, it is important to understand that the transport cart 1 is specially configured to handle a bed 31 and in particular to move a bed 31 on a surface 30. Key features of a bed 31 in relation to the transport cart 1 is that a bed 31 is moved by attaching the transport cart 1 to a bed end 32 of a bed 31 by entering part of the transport cart 1 from a bed end 32 into a duct 33 formed underneath and having a height 34 and a depth 35 until a bed wheel 36 emerges, wherefrom the duct has a height 34′ (34>34′).

FIG. 3A shows a transport cart 1 positioned in relation to a bed 31. The second wheel arrangement 8 has a height that is less than the height 34′ i.e. some 30 cm and has entered the duct 33 from the bed end 31 and passed the bed wheel 36 since the X-bar 11 extends longer in the X-direction 3 than the depth 35′ of the bed wheels 36 when the grip 9 is at a location for gripping the bed wheel 36.

Furthermore, FIG. 3A shows the grip 9 with the wheel enclosure 16 enclosing the bed wheel 36 and the wheel support plate 17 ready to receive one face of the bed wheel 36 and the wheel gate 19 in a closed position so that the bed wheel 36 is confined. Furthermore, there is a wheel stop plate 40 that raises above the projection of an axle and of a bed wheel and about 90 degrees from level thereby working as a stop, or emergency stop, of the bed wheel 36.

The wheel enclosure 16 is in this embodiment connected to the chassis 6 by a grip connector 41 that further interacts with a grip pivot joint 42.

Thereby, the grip 9 can pivot about the grip pivot joint 42 and the grip 9 will raise with a bed wheel 36 from the surface 30 by use of grip raising means 43 as will be detailed.

FIG. 3B indicates the transport cart 1 from FIG. 3A, but with the grip 9 raised.

Furthermore, the wheel support plate 17, the wheel fences 18, 18′ and the wheel gate 19 forming the wheel enclosure 16 and the wheel opening 20 as configured by example constitutes a wheel-locking means 44 as the gravitational force on a bed wheel 36 from the bed end 32 will provide the locking force and lock the bed wheel 36 in the wheel opening 20 and rest at the wheel support plate 17, preferably the downward edge of the wheel support plate 17, and the wheel gate 19. The wheel fences 18, 18′ will merely block sideways movement of the bed wheel 36. Thereby, a wheel-lock is formed when the bed wheel is lifted off the ground.

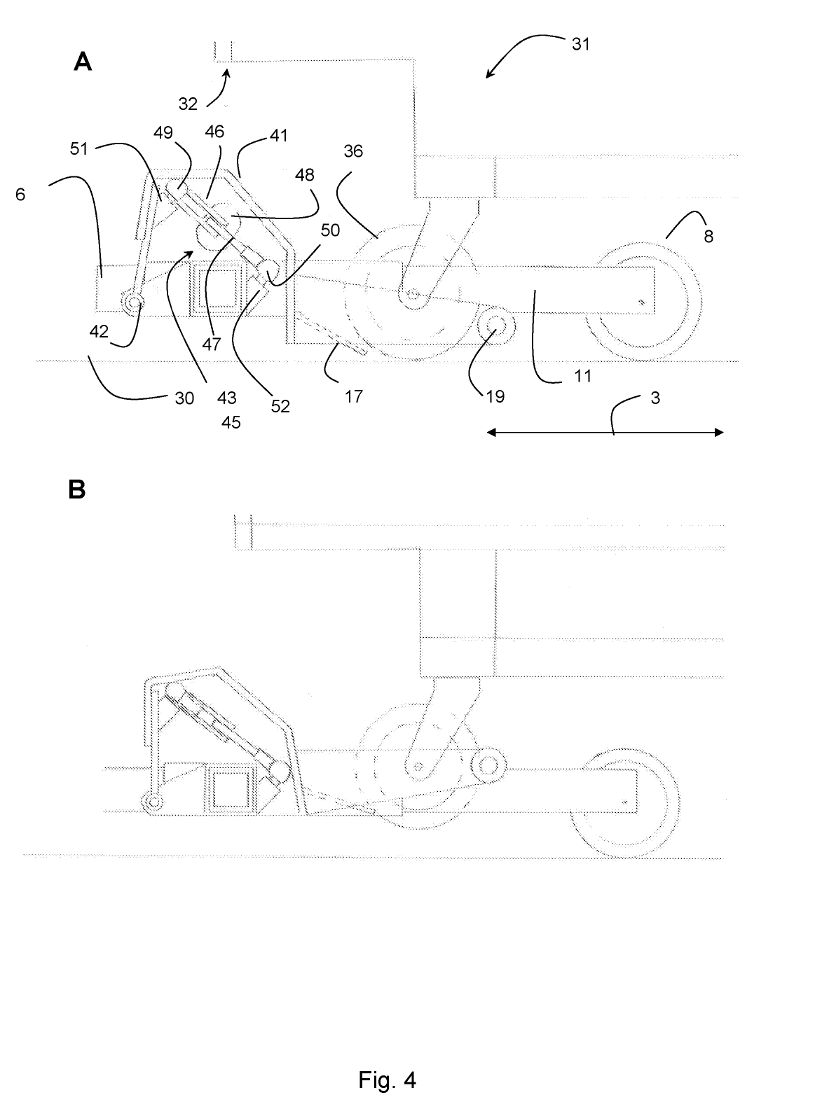

FIGS. 4A and 4B shows a transport cart 1 in similar situations as in FIG. 3, but with a ghost view showing an embodiment of a grip-raising means 43 shown in two positions: A, where the grip 9 is placed so that a wheel enclosed by a grip 9 has contact to a surface 30 and B, where the grip 9 is raised and a bed end 32 is raised from the surface 30.

The numerals from FIG. 4A also apply to 4B.

The grip-raising means 43 in this embodiment are an arm arrangement 45 comprising an upper arm 46 and lower arm 47 joint together by an elbow joint 48 at one end and at the other end terminated in an upper arm joint 49 and lower arm joint 50, working in an upper arm attachment 51 and an lower arm attachment 52, respectively.

The upper arm attachment 51 is fixed to the grip joint 41 and the lower arm attachment 52 fixed directly to the chassis 6 in such that stretching the arm arrangement, the grip 9 will pivot around the grip pivot joint 42 and raise the grip 9.

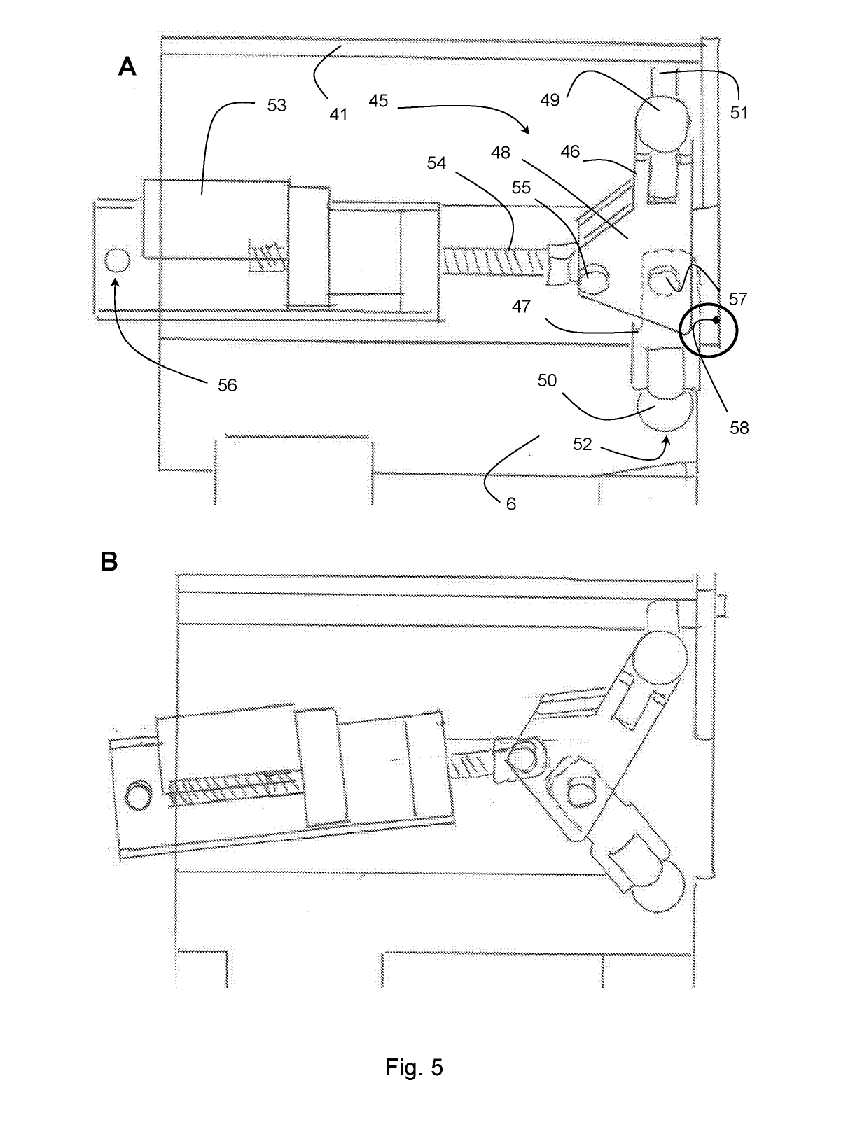

FIG. 5 shows an embodiment of a grip raising means 43 shown in two positions: A and B. The numerals from FIG. 5A apply to FIG. 5B.

The figures show the grip raising means 43 implemented as an arm arrangement 45 with an upper arm 46 and lower arm 47 joint together by an elbow joint 48. The upper arm 46 is terminated in an upper arm joint 49 configured to work in an upper arm attachment 51 that is connected to the grip joint 41. Likewise the lower arm 47 is terminated in a lower arm joint 50 configured to work in a lower arm attachment 52 that is connected to the chassis 6.

In this embodiment the lower arm joint 49 and upper arm attachment 51 as well as the lower arm joint 50 and the lower arm attachment 52 are ball-and-socket joints arrangements.

The arm arrangement 45 is operated by an arm actuator 53 configured to linearly move an arm actuator bar 54 pivotally joined to the elbow 48 at an arm actuator bar joint 55.

The arm actuator 53 is a motor and the arm actuator bar 54 is a threaded bar interacting with the motor.

The arm actuator 53 is pivotally connectable to the chassis 9 at an arm actuator joint 56.

The lower arm 47 is pivotally connected to the elbow 48 at an elbow joint 57 so that the lower arm 47 can bend in relation to upper arm 46.

FIGS. 5A and 5B shows how the arm actuator 53 by displacing the arm actuator bar 54 pushes and pulls the elbow 48 in the arm arrangement 45 thereby essentially perpendicular to the translocation direction of the arm actuator bar 54 increases and decreases the distance between the upper arm joint 49 and lower arm joint 50 thereby via the arm attachments 51,52 moving the grip joint 41 relative to the chassis 6 and thereby, as seen in FIGS. 4A, 4B raising and lowering the grip 9 from the surface 30.

In FIG. 5A, the arm arrangement 45 is in an essentially straight position, say at 0-degree between the upper arm 46 and the lower arm 47. In FIG. 5B, the aim arrangement 45 is in a bend position, say at a negative degree between the upper arm 46 and the lower arm 47 when the distance between the arm actuator joint 56 and the arm actuator bar joint 55 is shortened relative to the straight position by the arm actuator 53.

It is understood from the figure that the upper arm 46 and the lower arm 47 can be “over-straightened” or “over-stretched” i.e. in a positive degree between the upper arm 46 and the lower arm 47 when the distance between the arm actuator joint 56 and the arm actuator bar joint 55 is extended or lengthened relative to the straight position by the arm actuator 53.

In the over-stretched position part the arm arrangement is configured with an arm lock support 58, which is this case is a contact point between the elbow 48 and the chassis 6.

When the arm arrangement 45 is bent, the grip 9 can be positioned and raised to a top point when the arm arrangement 45 is straight. In this interval, forces from a bed on the grip 9 are transferred to the chassis 6 and the arm actuator 53 and arm actuator bar 54.

When the arm arrangement 45 is over-stretched, the grip 9 is held and locked in a raised position, preferably at point just below the top point at the straight position. At this position, the forces from a bed on the grip are transferred to the chassis 6 and the arm lock support 58. In particular, the arm actuator 53 and arm actuator bar 54 are released from forces in this position.

Furthermore, this embodiment of the arm arrangement 45 not only raises the grip 9, but also tilts the grip 9 so that a wheel from a bed is secured or locked both during raising and when in the over-stretched position suitable for transport or movement of a bed.

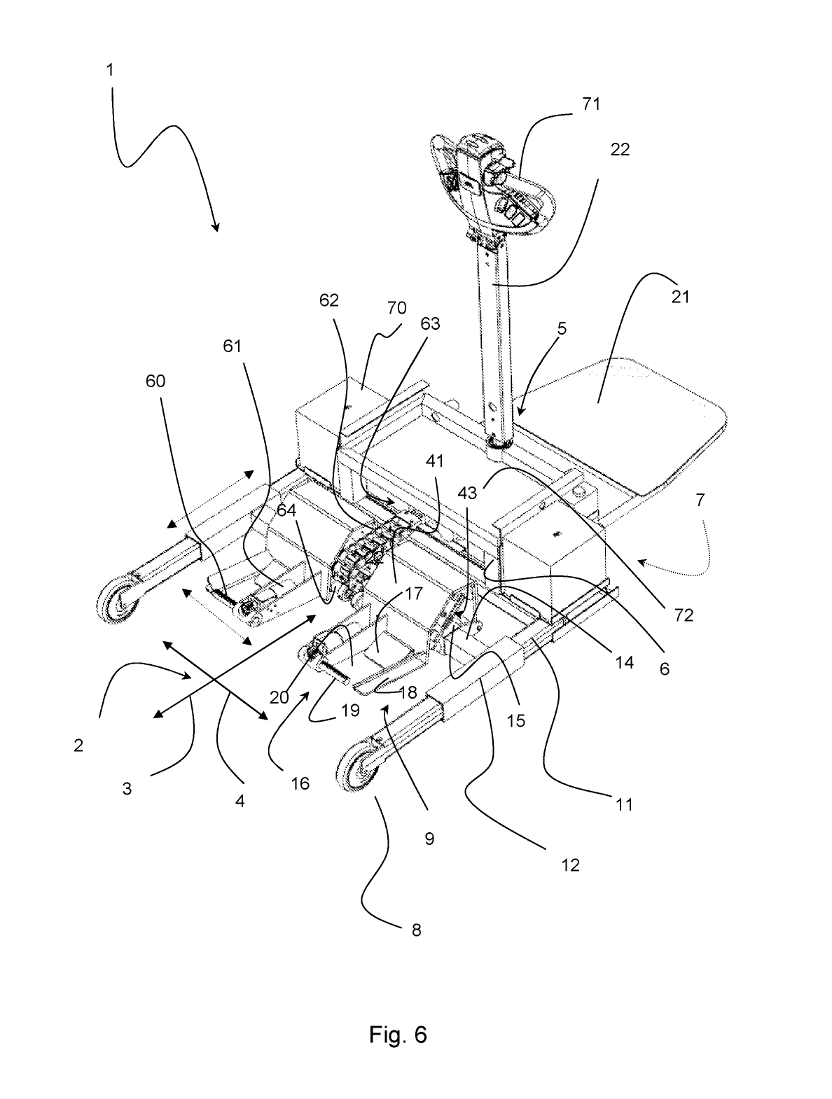

FIG. 6 shows an isometric view of a transport cart 1 based on assembled elements from above. The transport cart 1 has two grips 9 with the same elements, but mirrored and for the purpose of simplicity only one is referenced.

The second wheel arrangement 8 consists of two wheels each terminating the X-bar 11 and spaced to embrace a pair of bed wheels of a bed. The X-bar 11 and the hence the second wheel arrangement is positioned low thereby enabling grip 9 to be between the contact point of the second wheel arrangement 8 with the surface 30 and the contact point of the first wheel arrangement 7 and with the surface 30.

The wheel gate 19 opening and closing the wheel enclosure 16 is in this embodiment a threaded gate bar 60 interacting with a gate motor 61 and configured to move linearly, thereby opening and closing the wheel enclosure 16.

The wheel fences 18, 18′ are spaced with a certain width to allow for some flexibility in positioning the grip 9 in front of a bed wheel 36. Likewise, the wheel support plate 17 has a certain width to accommodate a bed wheel 36. The length of the gate bar 60 and hence the wheel gate 19 is adjusted accordingly.

Thereby, the wheel enclosure 16 on the grip 9 can be operated automatically.

In this particular embodiment, the X-positioning means 10 further comprises a belt connection 62 coupled to an X-position motor 63 located on the chassis 6. The belt connection 62 is at one end fixed to the centre part of the Y-bar 14, which at both ends is fixed on the X-gliders 12, 12′ gliding on the X-bars 11, 11′. At the other end, the belt connection is coupled to the X-position motor 63 that can move linearly so that the belt connection 62 can shorten or lengthen its length and thereby positioning the grips 9,9′ in the X-direction 3.

In this particular embodiment, the Y-positioning means 13 are partially hidden underneath the grip joint 41 and made of a Y-position motor 64 that is fixed to the chassis 6 and turns a Y-threaded bar 65 that works in a Y threaded hole 66 on the Y-glide 15 of the grip 9. Thereby, by turning the Y-threaded bar 65, the grip 9 will move along the Y-bar 14 and thereby enabling positioning the grip in the Y-direction 4 to accommodate the beds 31 with bed wheels 36 of varying distances.

In this particular embodiment, the grip raising means 43 are placed under the grip joint 41 and a grip raising motor 67 is implemented in the arm actuator 53 for transferring power to the arm actuator bar 54 for a linear movement to stretch and bed the arm joint arrangement 45 that can raise and lower the grip 9 and thereby lift a bed end 32 off a ground.

In this particular embodiment, the X-positioning and the Y-positioning of the grips are automated. In an alternative embodiment, the positioning of the grips is manual.

In this automated embodiment, each motor or actuator is powered by batteries 70 and each motor or actuator is configured to be controlled by a steering board 71, which in this embodiment is located at the end of the steering 22.

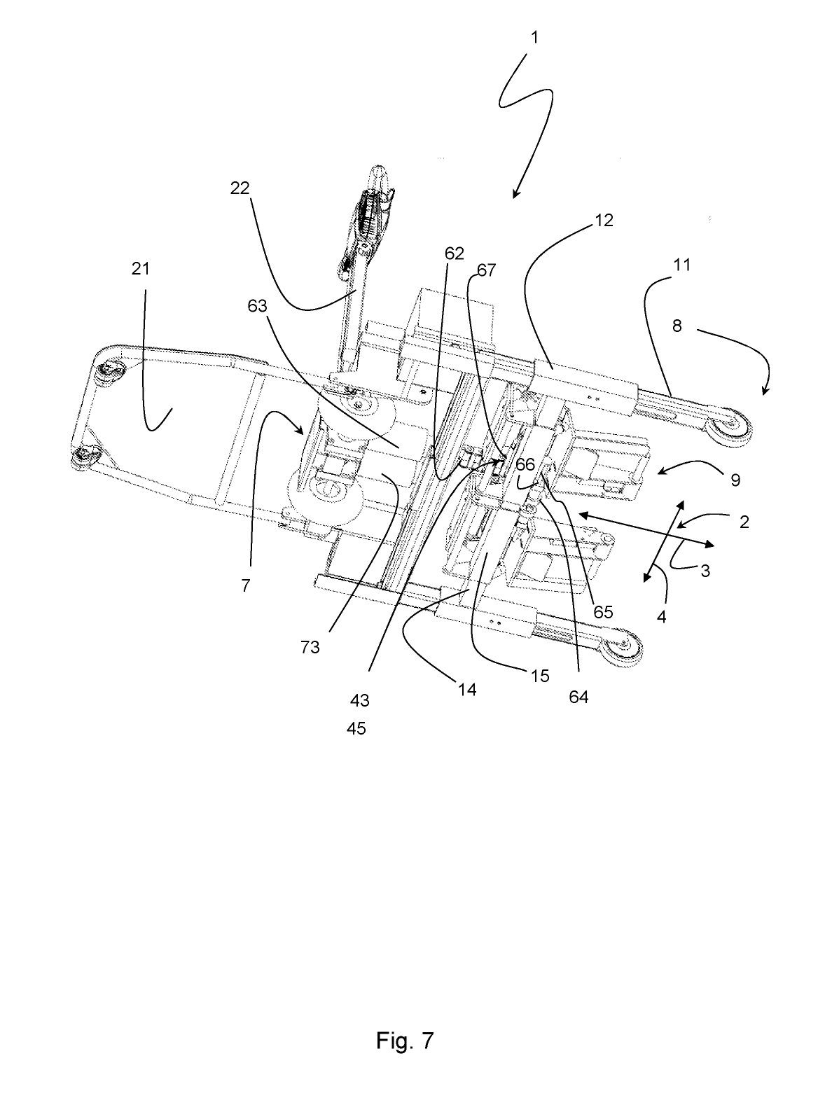

FIG. 7 shows an isometric view of the transport cart 1 from FIG. 6 seen below from below.

From this view a drive motor 73 configured to drive the wheels of the first wheel arrangement 7 is seen.

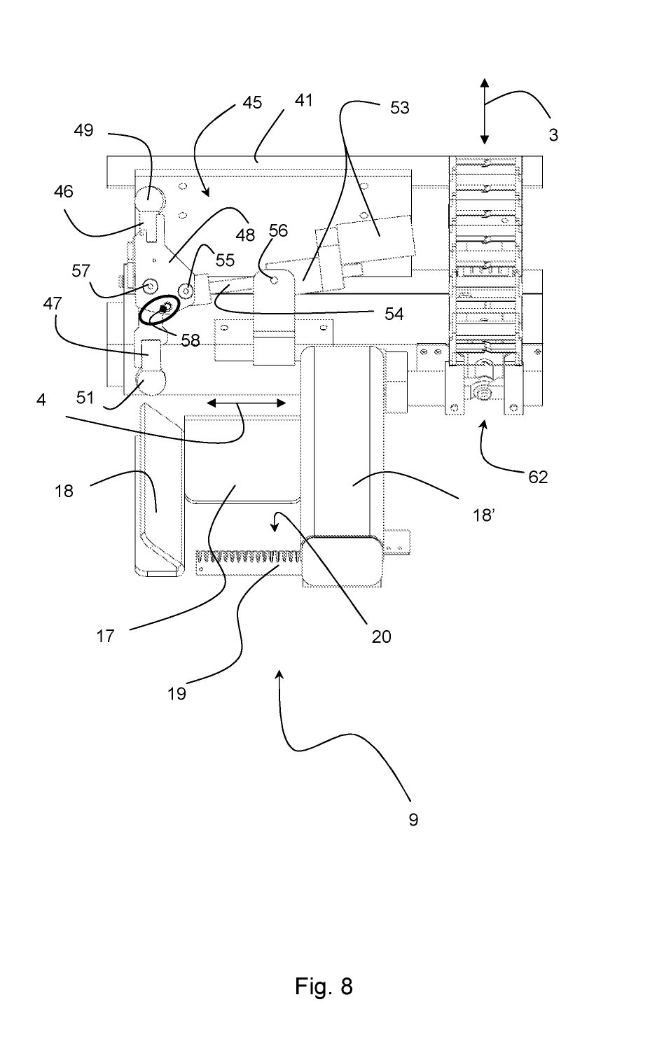

FIG. 8 shows a detailed view of a grip 9 that can be relatively positioned in the X-direction 3 by a belt connection 62. The grip 9 can also be relatively positioned in the Y-direction 4. Details of a wheel enclosure 16 with a wheel support plate 17 and two wheel fences 18 and a wheel gate 19 forming a wheel opening 20 are shown.

The wheel enclosure 16 is connected to an arm arrangement 45 which is disclosed in FIGS. 5A and 5B. In this embodiment of the arm arrangement 45, the arm lock support 58 is formed as a contact point between the lower arm 47 and a bolt inserted in the elbow 48 so that when extending the actuator bar 54, the elbow 48 (or parts of the lower arm) will overstretch and the bolt will make contact with the lower arm 47 preventing the lower arm 47 and upper arm 46 to stretch any further. In this case the bolt and the lower arm 47 forms the arm lock support 58.

What is claimed is:

1. Transport cart having an X-Y orientation with an X-direction essentially being the driving direction and a Y-direction essentially being perpendicular to the X-direction, both relative to a fixed A-Point, which transport cart is for working on a surface and thereon moving a bed with a bed end and a duct raised from the surface to a height and entering underneath a bed in depth and which bed is supported by bed wheels, which bed preferably is a hospital bed, which transport cart comprising:
a chassis supported by at least a first wheel arrangement and a second wheel arrangement, which wheel arrangements are configured to support the chassis and to drive the chassis in the X-direction, which first wheel arrangement interacts with steering means and which second wheel arrangement is spaced from the first wheel arrangement in the X-direction and is arranged to face and enter a duct of a bed end, and which chassis further supports
at least one grip configured to grip a bed wheel of a bed and for moving a bed, wherein said chassis further comprises an X-positioning means configured to move said at least one grip relative to the position A in the X-direction for positioning the grip to engage with at least one wheel of a bed.

2. Transport cart (1) according to claim 1, wherein said chassis further supports a Y-positioning means for moving said at least one grip relative to the position A in the Y-direction in the X-Y-plane for positioning the grip to engage with at least one bed wheel of a bed.

3. Transport cart according to claim 1, wherein said X-positioning means comprise a linear X-bar extending in the X-direction and the grip attached to an X-glider configured to glide on the linear X-bar for positioning the grip in the X-direction.

4. Transport cart according to claim 2, wherein said Y-positioning means comprises a linear Y-bar extending in the Y-direction and the grip attached to a Y-glider configured to glide on the linear Y-bar for positioning the grip in the Y-direction.

5. Transport cart according to claim 1, wherein said grip comprises a wheel support plate configured to receive and support a wheel and sided by two wheel fences forming a wheel enclosure closable by a wheel gate facing the wheel support place, which wheel enclosure preferably has a wheel opening downwards or is U-shaped for holding a bed wheel in position by its geometric shape and the gravitational force.

6. Transport cart according to claim 5, wherein said wheel gate is a gate bar with threads interacting with a gate motor thereby forming an actuator for linearly moving said gate bar.

7. Transport cart according to claim 1, wherein said chassis further supports grip-raising means connected to said grip and configured to raise said grip from above a surface.

8. Transport cart according to claim 1, wherein said chassis further supports wheel-locking means configured to lock a bed's bed wheels to the grip.

9. Transport cart according to claim 8, wherein said wheel-locking means comprise tilting-means for tilting said grip and arranged so that when tilted, gravitational forces due to the weight of a bed constitute a locking force; preferably the tilting is towards the grip support plate.

10. Transport cart according to claim 1, wherein said chassis further supports a combined grip raising and tilting means implemented as an arm arrangement comprising:
a lower arm with an lower arm joint engaging in a lower arm attachment fixed on the chassis;
an upper arm with an upper arm joint engaging in an upper arm attachment fixed to the grip or to a grip connector pivotably connected to the chassis at a grip pivot joint; which lower arm and upper arm pivotably connects at
an elbow in an elbow joint so the lower arm and the upper arm can bend about the elbow joint, which elbow further has an arm actuator bar joint connecting an arm actuator bar to
an arm actuator connected, preferably pivotably, to the chassis at an arm actuator joint and configured for pulling and pushing the elbow to bend and stretch the lower arm and upper arm relatively to each other.

11. Transport cart according to claim 10, where the arm arrangement is configured so that the lower arm and upper arm can over-stretch and with the arm arrangement having an arm lock support point that defines a maximum over-stretch and supports at least part of the load-forces from each said upper arm and upper arm.

12. Transport cart according to claim 11, where
said arm lock support is a bolt inserted in the elbow in a position between the elbow joint and the arm actuator joint or
said arm lock support is a contact point between the lower arm, the upper arm or the elbow with the chassis.

13. Transport cart according to claim 1, wherein said chassis further comprises a drive train, preferably comprising batteries, an electric motor coupled to the first wheel arrangement for driving said wheels and further configured to be controlled by a steering board.
